(19) United States
(12) Patent Application Publication
(10) Pub. No.: US 2016/0107844 A1
(43) Pub. Date: Apr. 21, 2016

(54) MOBILE ELEMENT OF AN ELECTROMAGNETIC DIRECT DRIVE, HAVING A CLEANING FUNCTION

(71) Applicant: KHS GMBH, Dortmund (DE)

(72) Inventors: Thomas LELIE, Kleve (DE); Wilfried EHMER, Dortmund (DE)

(21) Appl. No.: 14/894,117

(22) PCT Filed: May 16, 2014
(86) PCT No.: PCT/EP2014/060064

§ 371 Date: Nov. 25, 2015

(30) Foreign Application Priority Data
May 27, 2013 (DE) 10 2013 105 430.7

(51) Int. Cl. B65G 45/22; B65G 54/02; B65G 45/24

(52) U.S. Cl. CPC B65G 45/22; B65G 45/24; B65G 54/02

(57) ABSTRACT

An apparatus for moving objects includes individually-controllable mobile elements, and a transport element that has electromagnetic direct drive and that defines a movement path. The mobile elements circulate on the movement path, Among the mobile elements is a cleaning unit for cleaning the movement path.

The invention relates to a linear transporter, preferably in the configuration as an electromagnetic direct drive with a path of movement on which at least one, and preferably a plurality of, mobile elements circulate in an individually controllable manner.

Such electromagnetic direct drives can be used, for example, on packing machines for containers and undertake the most widely differing packing steps. Along the packing machine, from a wide container stream, by means of channel division, containers can be converted into a plurality of single-path container streams, and with at least one division and/or compaction unit for dividing and compacting a predetermined number of containers, forming compacted or shaped container groups or part bundles, and subsequently being gathered together in each case to form one later single bundle.

Containers in the meaning of the invention are, for example, bottles, cans, tubes, pouches, in each case made of metal, glass, and/or plastic, i.e. for example also PET bottles, but also other packaging means, in particular such as are suitable for filling with liquid or viscous products, but also for holding foodstuffs, and also containers which have already been brought together to form groups (multipacks, bundles).

In detail, the production of the bundles takes place, for example, in what is referred to as a packing machine, in such a way that the containers are conveyed on a transport plane of a transporter, oriented standing upright and with their container axis in a vertical direction or essentially vertical direction, in a mass transport or in a wide container stream, in which the containers may exhibit a random orientation in respect of distinctive containers and/or equipment features. This wide container stream is then converted into a plurality of single-path container streams by channel division. In further process steps, the division takes place of the containers forming the later bundles or container groups, from the single-path container streams, the grouping together of the necessary number of containers in each case to form a compacted container group, in which the containers are in contact with one another with several casing or circumferential surfaces, i.e. with contact or touch surfaces, and the connection of the containers of each container group to form the compact and solid or stable bundle.

In this situation, the individual containers are aligned in accordance with distinctive design features, such that the respective bundles comprise containers which are oriented according to the specific requirements in each case. It is possible for the individual containers of the bundle to be connected to one another, wherein, for example, slinging, for example, with a retaining band or other surrounding element is conceivable. Such a surrounding element can be, for example, a carton cut-out or a film cut-out, which is laid on the bundle concerned and secured accordingly. The carton ends can be adhesively bonded to one another. In a shrink tunnel, the films which are initially laid in place are then shrunk on. It is also conceivable for the bundles to be provided with a stabilising underlay, which is configured, for example, as a card cut-out, on which the containers stand upright. Such an underlay is appropriate if it is intended, for example, that the later bundle should be formed of a plurality of part bundles. In this situation, the underlay can be arranged such that the one part bundle is set on the other. Following this, a surrounding element can be provided, in order to encompass the stacked bundles. The card cut-outs are, as such, preferably taken in an unfolded state from a magazine, and, before being conveyed to the later bundle, are folded, wherein an appropriately configured folding station is used. To form the film cut-outs, a film roll is unrolled to form a film web, wherein the film sections concerned are cut from the film web. For this purpose a film cutting station is appropriate for use, such that the respective film cut-out has the required dimensions of the bundle which is to be packed in each case. In a further embodiment, it is possible for a spacer element to be arranged between the containers of the later bundle, which is configured, for example, as a web or a frame. This frame is in most cases formed from a card, and is configured as a frame before being inserted into the later bundle, wherein a spacer element inserter is used, which can be designated, for example, as a web inserter or frame inserter. If the bundle is formed, and has left the shrink tunnel, then a pack router can be provided for the new orientation of the bundle.

The principle is known of bringing together or forming a plurality of articles into an article group, and, from the article groups, making use of shrink films (e.g. U.S. Pat. No. 7,726,464 A1), producing firm or transportable storage and transport units or bundles. Disadvantageous in this situation is, among other things, that the films used in this situation and in particular the shrinking on of the films by heat or energy application incurs costs which are not insubstantial.

It has also already been proposed that transportable bundles be produced in that the containers which, in each case, are formed into a container group are packed by a sling surrounding the container group in the form of a loop (DE 10 2009 025 824 A1, DE 10 2009 004 271 A1, DE 41 26 212 A1), i.e. are bound together to a bundle, which represents a particularly economical and simple possibility for producing bundles or transport and storage units. The slinging can also be adhesively bonded to the containers. A disadvantage with slinging, however, is that the first time a container is taken out of such a bundle, the containers remaining in the bundle are no longer held together by the slinging. This applies not only if the slinging is separated or cut, but also if it is possible to take a container out of the bundle without separating the slinging.

Moreover, during the transport of such bundles on a band conveyor, there is always the risk that cylindrical or largely cylindrical articles, such as cans, bottles, or containers, can be moved out of a nested position due to vibrations, shocks, etc., i.e. cause a gap in the adjacent row. In order to prevent this, with known bundles, a very high tension is applied on the slinging.

Conversely, DE 10 2006 037 105 A1 relates to a method for the bringing together of bottle packets, with which, on both sides of a path, a rotary star is provided, which presses bottle necks in clamps on bottle carriers. The bottle pack is additionally surrounded with a band or an envelope (film).

According to DE 23 31 193 an adhesive is applied to containers in narrow surface areas or rows, wherein adjacent surfaces in each case, which are not provided with adhesive, are intended to allow for the pack to be gripped for the purpose of carrying. At the adhesion points the containers are adhesively bonded to one another. EP 2 096 039 A1 likewise discloses providing containers with an adhesive agent, wherein, however, a shrink film is additionally arranged around the bottle packet.

From EP 2 500 296 A1 a device and method are known for the grouping of unit products along a conveyor path. By means of divider elements engaging into the conveyor flow, gaps are formed between unit products following one another. The divider elements can be individually controlled in their thrust movement and/or speed along the movement path due to the gearless direct drives used. The divider elements rise up from beneath the movement path, divide a number of containers off from the container stream, and then hold up the stream, so that a gap occurs between the separated containers: The divider elements then speed up and retract again below the level of the movement path. To this extent, EP 2 500 296 A1 actually only combines the division technique with divider fingers, arranged on circulating paths, known before the application or priority date, with a drive system which is formed by gearless direct drives.

DE 10 2011 081 705 A1 is likewise concerned with a method and device for the grouping of containers. In this situation, the device comprises two conveyor devices with different speeds. The second conveyor device is faster than the first conveyor device. Accordingly, the containers reaching the second conveyor device are moved faster than the containers on the second conveyor device. A gap is therefore formed between the containers on the second conveyor device. By means of a pusher device or retention device, the containers on the second conveyor device are speeded up, slowed down, and/or pushed against one another, such that the original gap is changed. In this situation, for example, the following container is pushed onto the preceding container. The corresponding acceleration is attained by means of linear motor drives, wherein the individual elements of the pusher or retention device can be individually controlled.

Electromagnetic direct drives, with function tools arranged at their mobile elements, can be allocated to corresponding components of the packing machine. Provision can be made, for example, for the mobile elements to carry out the feed transport of film cut-outs, with which the bundles are wrapped. It is also conceivable for the mobile elements to be arranged along a transfer plate, in order for the bundles concerned to be transported accordingly. An electromagnetic direct drive can also, for example, carry out transport tasks with its mobile elements in a shrink tunnel. The electromagnetic direct drives used in the packing machine require cleaning and/or supply with operating media. In particular, the cleaning of the movement path, for example, is carried out with the electromagnetic direct drive switched off, and therefore of the packing machine components connected to it, i.e. the entire packing machine. Switching off, for example, only for cleaning purposes, means substantial reduction of the actually attainable performance capacity of the packing machine concerned.

The object of the invention is to provide a linear transporter as an electromagnetic direct drive, which, despite the necessary cleaning, switching off the system components connected to it can be avoided.

To solve this object, an electromagnetic direct drive according to claim 1 is provided.

Further embodiments, advantages, and possible applications of the invention are also derived from the following description of exemplary embodiments. In this situation, all the features described are in principle the object of the invention, individually or in any desired combination, regardless of their inclusion in the claims or reference to them. The contents of the claims are also a constituent part of the description.

According to the invention, a linear transporter in the preferred embodiment is provided as an electromagnetic direct drive with a circulating path, on which at least one, and preferably a plurality of mobile elements circulate, which can be individually controlled, and wherein at least one of the mobile elements purposefully comprises at least one cleaning unit.

The linear transporter, i.e. the electromagnetic direct drive, therefore comprises a closed movement path, on which the individual mobile elements are arranged, which circulate. The mobile elements can be individually controlled, such that each mobile element can have an individual speed. At an outgoing run of the movement path, the speed of the mobile elements located there is purposefully not equal to the mobile elements along a return run. This is advantageous, since in this way a very small number of mobile elements can be provided for, since the mobile elements moving along the return run overtake the mobile elements moving along the outward run. The mobile elements can carry function elements, such that in each case a part region of the packing machine is functionally covered by the linear transporter. For example, the mobile element can carry function elements such that a film cut-out can be conveyed to the bundle.

The movement path can of course comprise a lock arrangement such as to remove via the lock any unnecessary mobile elements, or any mobile elements which require examination. The lock arrangement can of course also be used to introduce elements.

The linear transporter, i.e. the electromagnetic direct drive, is configured in the form of an electromagnetic path, wherein the mobile elements circulate in a gearless manner on the path in a directly controllable fashion, wherein the desired speed of the respective mobile element in each case can be individually controlled. For this purpose, an interface of the movement path can be connected to a control unit.

For the purpose of cleaning alone, the mobile element is provided with the cleaning unit. The mobile element can in this situation only carry out the function of cleaning, i.e. it does not comprise any further function elements, as the other mobile elements do. It is possible in this situation for the mobile element with the cleaning unit to circulate constantly with the other mobile elements, individually controlled. This is possible, because the mobile element concerned can be actuated in such a way that the means of effect of the mobile elements with the function elements allocated to them is not influenced. It is also possible, however, for one of the mobile elements to comprise the cleaning unit in addition to the pertinent function elements. In this situation, the specific mobile element has a double function, namely the function of cleaning and the function of the packing machine components, which the other mobile elements without cleaning units also have.

Instead of the possibility of the mobile element with the cleaning unit constantly circulating with the other mobile elements, the mobile element with the cleaning unit can also be introduced via the optional lock arrangement at specified intervals of time or at a particular desired time. Accordingly, the mobile element with the cleaning unit is not arranged constantly circulating on the movement path, but can carry out the cleaning task cyclically, either at predetermined intervals of time, or at individually required times.

In a purposeful embodiment, the mobile element with the cleaning unit comprises a storage medium for, for example, liquid media, i.e. preferably a tank for the cleaning fluid. The mobile element with the cleaning unit can circulate independently with the cleaning medium. It is preferable in this situation if a central filling station is provided, which is arranged, for example, at a central location. In this situation, the filling station can be arranged outside the movement path, wherein the mobile element concerned can be removed via the optional lock arrangement in order to reach the filling station. This can simultaneously be the waiting position of the mobile element, from which it can be introduced via the optional lock arrangement. The storage medium can also be configured as removable, such that it can be filled without the mobile element having to be moved separately.

It is also possible, however, that a filling station is arranged along the movement path and/or at a specific location on the movement path. In this situation, the filling station can either extend as a line over the entire movement path, or be arranged stationary at a central location. Manual and/or automatic filling of the liquid medium into the storage medium is possible.

In an advantageous embodiment, the storage medium comprises a filling aperture through which the cleaning medium passes into the storage medium. In order to avoid the emergence of cleaning liquid via the filling aperture, the aperture is fitted with a suitable valve, which does indeed allow filling, but avoids an emergence of liquid. In a preferred embodiment the cleaning medium is injected into the storage medium. In this situation, a relatively large amount can be filled in a short time, for which purpose the filling, i.e. injection, is possible under high pressure. The filling process is of course controllable, wherein the amount consumed is recorded, and quantity required to be filled is actuated accordingly.

The cleaning unit in the meaning of the invention can also comprise an operational medium unit. This can be integrated in the cleaning unit, or arranged as a separate unit at the mobile element. It is also possible for a mobile element to be configured with the operating movement unit, and another mobile element with the cleaning unit. Both mobile elements can also comprise the function elements referred to heretofore.

At the mobile element concerned, the respective medium can be conveyed out of the respective storage medium under the force of gravity, by centrifugal force, or by other means, preferably driven by a pump, to the respective consumption point. In this situation, a controllable spray head, capable of movement in all directions, can be in connection by way of a line, arranged at the mobile element, with the storage medium, such that all the desired locations can be reached with the respective medium, i.e. with the cleaning liquid and/or with the operational medium. It is also possible, however, for only the movement path to be cleaned, for which purpose appropriate openings or spray apertures are provided on an inner surface of the mobile element oriented towards the movement path. The openings are, of course, in connection with the line or lines. In addition, choke elements, preferably controllable, can be provided, such that the pressure of the cleaning liquid can be controlled separately, i.e. is adjustable. It is also possible for a wiper element, such as a sponge or felt element to be provided, which is moistened if required. In that situation, the wiper element can be connected via lines to the tank. It is also possible to do without a tank, and for the wiper element to be moistened at a central position, such as in the waiting position. The cleaning unit can clean the entire linear transporter, i.e. the complete electromagnetic direct drive, wherein not only the movement path can be cleaned, but also a possibly separate scanner.

The mobile element can also comprise a drying unit or simply a dry cleaning element, if it is intended that a cleaning liquid should be done without. The drying unit can produce an air or gas flow under pressure, and in this way dry, for example, elements wetted with the cleaning liquid. In this situation, a suction air or gas flow can be produced as well as an air or gas flow under pressure. The air or gas flow under pressure can of course also take on a cleaning function. It is also possible to provide a wiping lip, which is preferably arranged at the mobile element located on the movement path, and in this way wipes off the wetting liquid.

It is purposeful if the cleaning liquid is carried forwards, seen in the direction of movement of the mobile element, wherein the drying is carried out backwards seen in the direction of movement.

It is of course possible in each case for a separate mobile element to comprise the components referred to separately. Also possible, however, are combinations of individual components with other components on a mobile element, wherein, naturally all the components mentioned can be arranged on the mobile element.

The invention is explained in greater detail hereinafter on the basis of the figures, relating to an exemplary embodiment. The figures show:

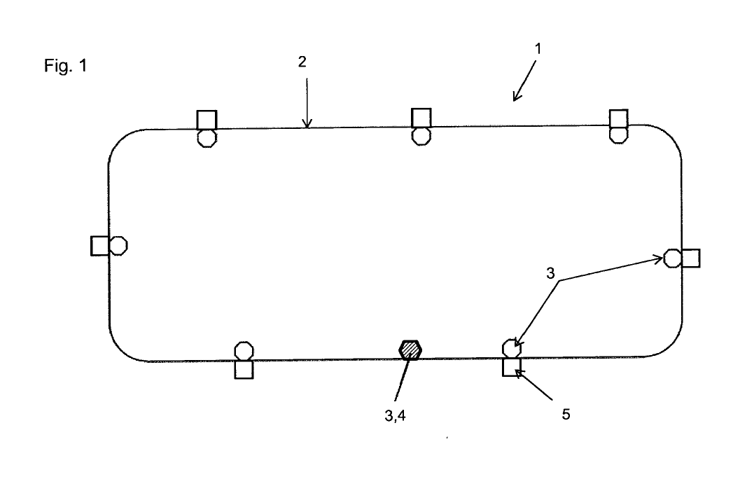

FIG. 1 an electromagnetic direct drive with circulating mobile elements,

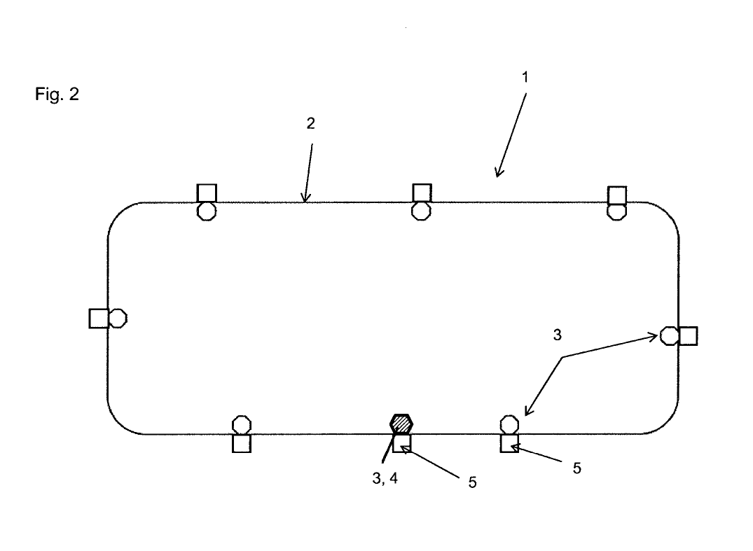

FIG. 2 the electromagnetic direct drive from FIG. 1, wherein one of the circulating mobile elements has a multiple function,

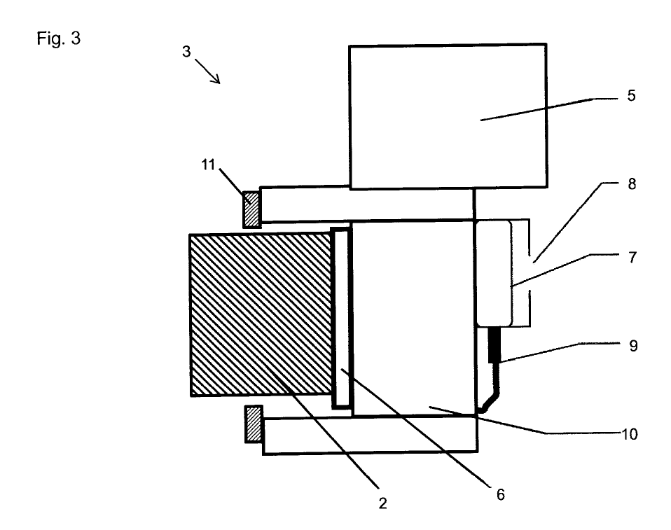

FIG. 3 the mobile element with a multiple function as an individual unit in a principle view, and

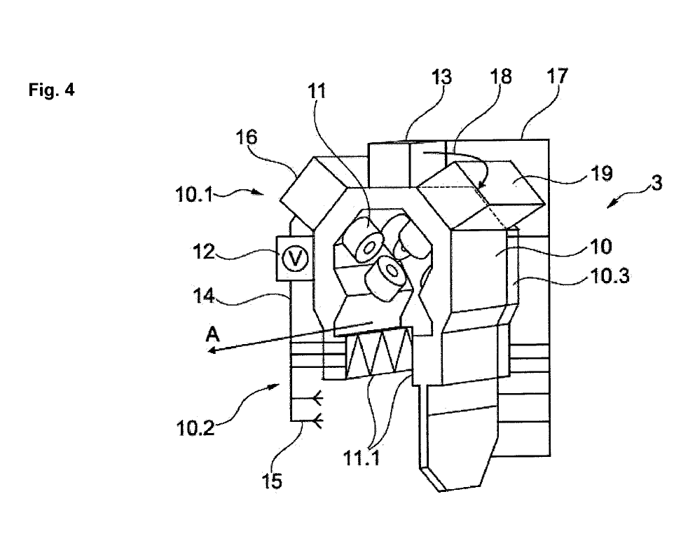

FIG. 4 the mobile element with a multiple function in an alternative embodiment, in an alternative view.

In the different figures, the same parts are always provided with the same reference figures, for which reason they are, as a rule, also only described once.

FIG. 1 shows a linear transporter 1 in the embodiment as an electromagnetic direct drive 1 with a movement path 2, on which at least one, and preferably a plurality of mobile elements 3 circulate, which can be controlled individually. At least one of the mobile elements 3 comprises at least one cleaning unit 4.

With the embodiment according to FIG. 1, the mobile elements 3 carry either the cleaning unit 4 or function elements 5. The function elements 5 are adapted in their configuration and function to a part component, for example, of a packing machine. The function elements can serve, for example, to fulfil gripping or pushing tasks in connection with products, containers, or bundles which are to be transported or treated.

With the embodiment represented in FIG. 2, one of the mobile elements 3 comprises, in addition to the function element 5, the cleaning unit 4, such that the mobile element 3 concerned has a multiple function. The other mobile elements 3 comprise in each case the function element 5. As an alternative, the function element 5 can also be replaced by the cleaning unit 4, or the mobile element 3 can be formed overall as a cleaning element or cleaning carriage or slide. In this case, such a cleaning element or cleaning carriage or slide would be used as required, coming from a parked position, or circulate without function until a cleaning function is arranged.

The cleaning unit 4 in the meaning of the invention is to be understood such that it can convey a cleaning medium and/or an operational medium with it. The cleaning medium can be a cleaning medium, while the operational medium can be, for example, a fluid containing tenside or being easily fusible, gases, or a vaporous medium. In addition, the cleaning unit 4 can also comprise a dry cleaning element 6, such that, additionally or instead of a cleaning liquid, provision can be made for brushes, fabric rollers, or the like. In addition to this, the cleaning unit 4 can also comprise a drying unit, which removes the cleaning liquid, for example, from the cleaned movement path 2. The drying unit in the mechanical respect is configured as a scraper, for example in the embodiment shown as a wiping lip. The drying unit can, however, also produce air under the effect of pressure, and specifically either as suction air or as air under pressure, such that the cleaning liquid is either suctioned up or blown away.

FIG. 3 shows a mobile element 3, which comprises the function unit 5 and the cleaning unit 4. The mobile element 3 engages around the movement path 2, which can also be designated as a production track. The mobile element 3, in the representation selected according to FIG. 3, contrary to the movement path 2, comprises a storage medium 7, preferably for liquid media, i.e. for the cleaning liquid or for the operational liquid. It is possible to provide for a second storage medium, if it is intended that both cleaning liquid as well as operational liquid are to be carried along with the mobile element 3. In the embodiment shown, the cleaning unit 4 also comprises the dry cleaning element 6, such that cleaning with cleaning liquid as well as cleaning without liquid is possible. Not shown in FIG. 3 is a drying unit.

The storage medium 7 can preferably be configured as a tank, which comprises a filling opening 8. From the storage medium 7, a line 9 leads to consuming components, not shown, for example to a spray head for cleaning.

FIG. 4 shows a further exemplary embodiment on the basis of a mobile element 3, such as it is marketed in its basic form, i.e. only the carriages and movers without further fittings, wherein the guide rails or conveyor path is not shown in FIG. 4. The arrow A indicates the main direction of movement, wherein, however, the mobile element 3 can basically travel in both directions. The arrangement and type of the mover guide and the structural form of the mover is dependent on the respective rail and guide path and the load circumstances, and can, if required, be adapted or configured differently.

The basic body 10 comprises a media section 10.1, a task section 10.2 located in front in the travel direction and a discharge section 10.3 located in the rear in the travel direction, these essentially forming the cleaning unit 4. The travel rollers 11 are arranged on the running rail in such a way that the mobile element 3 can be moved free of any play, by means of the electromagnetic force which takes effect on the permanent magnets 11.1, and the mobile element 3 is driven.

The task section 10.2 is determined by nozzles or outlets 15, which are connected by means of a pump 12 and one or more lines 14 to a tank 10 arranged in the media section. The nozzles or outlets 15 are in this situation aligned in such a way that a liquid, vaporous, or gaseous medium are directed onto the guide rails or running track. In addition, it may be appropriate for the inner region of the mobile element 3 to also be subjected to fluid flow.

The discharge section 10.3 is defined by means for suction or taking up of the fluids or of dust and dirt particles in solution. For this purpose, in the exemplary embodiment shown, a line 17 is provided, which branches into a plurality of part lines, which end in suction apertures or nozzles, not shown, which are suitable for the taking up of the fluids or dust and dirt particles in solution as referred to heretofore. The line 17 is for this purpose in turn connected to a compressor 13, which conveys the substances taken up via a line 18 into a tank 18 and collects it there. As described heretofore, it may be advantageous for a wiping lip to be provided. Nozzles or outlets 15 or the line 17, and their branches, are represented only on one side in each case, but as a rule are arranged in each case on both sides, left and right, at the mobile element 3.

Moreover, depending on the anticipated dirt contamination, only a part of the elements are to be provided for. That is to say, it may be sufficient for only the task section 10.2 to be provided for, if a highly volatile cleaning liquid or a gas is being used for the cleaning and this is sufficient for the anticipated degree of dirt contamination. For this purpose, or in addition, the tank 16 can be configured as a pressure tank, which is filled and subjected to preliminary pressure as required, such that, instead of the pump 12, a controllable stress-relief valve is to be provided.

As an alternative, the task section 10.2 can comprise in particular a compressor, which suctions in ambient air exclusively via a fine filter, or, additionally to the fluid quantity from the tank 16, suctions a gas volume flow from the ambient air.

Moreover, a cleaning fluid can also be conveyed to the outside in a suitable manner, without leading this, together with the dirt and dust particles taken up, into an attached collection tank.

As an alternative, the mobile element can also be connected, by means of flexible feed and discharge lines, to central function or supply units, or, as required, connect to this by means of quick-action couplings, inasmuch as the spatial circumstances allow this.

It is to be emphasised that all the aforementioned elements for fluid take-up, emission, removal, or collection can be combined and adapted, depending on the cleaning task involved.

### REFERENCE NUMBER LIST

1 Linear transporter
2 Movement path
3 Mobile elements
4 Cleaning unit
5 Function element
6 Dry cleaning element
7 Storage medium
8 Filling opening
9 Line
10 Basic body
10.1 Medium section
10.2 Task section
10.3 Discharge section
11 Running roller
12 Pump
13 Compressor
14 Line
15 Nozzle or outlet
16 Tank
17 Line
18 Line
19 Tank

1-10. (canceled)

11. An apparatus for moving objects, said apparatus comprising a plurality of mobile elements, and a transport element, wherein said transport element comprises an electromagnetic direct drive and defines a movement path, wherein said mobile elements circulate on said movement path, wherein said mobile elements are individually controllable, wherein said mobile elements comprise a cleaning unit for cleaning said movement path, and wherein said transport element is selected from the group consisting of a transport slide and a transport carriage.

12. The apparatus of claim 11, further comprising a function element.

13. The apparatus of claim 11, wherein said cleaning unit) comprises a storage medium for liquid media.

14. The apparatus of claim 13, wherein said storage medium is disposed at a filling station along said movement path in a region of a waiting position of said cleaning unit.

15. The apparatus of claim 11, wherein said cleaning unit comprises at least one of a spray head and nozzle.

16. The apparatus of claim 11, wherein said cleaning unit is connected to at least one of a spray head and nozzle.

17. The apparatus of claim 11, wherein said cleaning unit comprises a dry cleaning element.

18. The apparatus of claim 11, further comprising a pump.

19. The apparatus of claim 11, further comprising a vacuum pump.

20. The apparatus of claim 11, further comprising a vacuum compressor.

21. The apparatus of claim 11, wherein said transport element comprises a linear transporter.

22. A method comprising cleaning of a linear transporter having a movement path on which individually-controllable mobile elements circulate, wherein cleaning comprises providing an individually-controllable mobile element that comprises a cleaning unit, causing said cleaning unit to circulate with said mobile elements, and cleaning said movement path with said cleaning unit.

23. The method of claim 22, wherein causing said cleaning unit to circulate comprises introducing said cleaning unit into said movement path at predetermined times.

24. The method of claim 22, wherein causing said cleaning unit to circulate comprises causing said cleaning unit to be constantly circulating along said movement path with said mobile elements.

25. The method of claim 22, further comprising using said linear transporter as a constituent of a packing machine.
